(19) United States
(12) Patent Application Publication
(10) Pub. No.: US 2011/0295648 A1
(43) Pub. Date: Dec. 1, 2011

(54) Computer and Computer Program for Evaluating the Sales Force Effectiveness of a Selected Business

(76) Inventor: Marty Nicholas, Sydney (AU)

(21) Appl. No.: 12/789,429

(22) Filed: May 27, 2010

(51) Int. Cl. G06Q 10/00

(52) U.S. Cl. 705/7.29

(57) ABSTRACT

A computer for evaluating the sales force effectiveness of a selected business includes a processor, a data communication device operatively connected to the processor and computer readable memory operatively connected to the processor and storing a program. The program comprises code adapted to calculate a final score representing the sales force effectiveness of the selected business by calculating the difference between the sales force effectiveness score of the selected business and a sales force effectiveness benchmark score which it also calculates. Also provided are computer executable steps for evaluating the sales force effectiveness of a selected business. Finally provided is a computer program product comprising a computer usable medium having a computer readable program code embodied therein, the computer readable program code adapted to be executed to implement a method for evaluating the sales force effectiveness of a selected business.

### FIELD OF THE INVENTION

The present invention relates to computers and computer programs used in evaluating the sales force effectiveness of businesses. The invention has been developed primarily for use by sales/marketing/management consultancies and will be described hereinafter with reference to these applications. However, it will be appreciated that the invention is not limited to this particular field of use.

### BACKGROUND OF THE INVENTION

Determining the sales effectiveness of the sales people/teams of a business in a quantitative sense, particularly in comparison to other businesses, is a difficult problem.

The sales effectiveness of a sales team is dependent on a multitude of factors, including:
1. The extent to which the sales team believe in what they are selling;
2. The extent to which the sales team understand the sales strategy and execution process;
3. Team motivation;
4. The motivation of the members of the sales team;
5. The extent to which sales coaching or other forms of on-the-job learning (e.g. buddy programs, training sessions, role modeling and networking) are utilized by the business;
6. The teams' level of product knowledge;
7. The availability of/access to sales tools;
8. The sales process employed; and
9. The amount of time spent on non-sales activities.

Therefore, it is often difficult for a sales manager or leader to assess the effectiveness or efficiency of their sales people/teams.

It is to be understood that, if any prior art information is referred to herein, such reference does not constitute an admission that the information forms part of the common general knowledge in the art, in Australia, the United States or any other country.

### SUMMARY OF THE INVENTION

The invention provides a computer and computer program for evaluating the sales force effectiveness of a selected business that overcome the hereinafore-mentioned disadvantages of the heretofore-known devices and methods of this general type.

With the foregoing and other objects in view, there is provided, in accordance with the invention, a computer is provided for evaluating the sales force effectiveness of a selected business and includes:
a processor;
data communication device operatively connected to the processor; and
computer readable memory operatively connected to the processor and storing a program, the program comprising code adapted to carry out the following steps when run by the processor:
   receiving sales effectiveness input data relating to the sales effectiveness of a plurality of businesses via the data communication device into the computer readable memory;
   receiving revenue growth rate data relating to the revenue growth rate of the plurality of businesses via the data communication device into the computer readable memory;
   receiving market sector growth rate data relating to the growth rate of the market sectors of which the plurality of business are respectively a part via the data communication device into the computer readable memory;
   calculating net real growth rate data for the plurality of businesses by normalizing the revenue growth rate data with respect to the respective market sector growth rate data;
   creating a first business data set comprising data in relation to businesses that fall within a first predetermined high range in terms of their net real growth rate data;
   creating a second business data set comprising data in relation to businesses that fall within a second predetermined high range in terms of their sales effectiveness data;
   creating a high performing business data set comprising data in relation to businesses that are common to both the first business data set and the second business data set;
   allocating a sales force effectiveness benchmark score that represents the average sales force effectiveness of the businesses in the high performing business data set; and
   calculating a final score representing the sales force effectiveness of the selected business by calculating the difference between the sales force effectiveness of the selected business and the sales force effectiveness benchmark score.

In accordance with a further feature of the invention, a quantitative score can be determined corresponding to the sales force effectiveness of a business and this score can be evaluated against a benchmark representing a proficient level of sales force effectiveness.

In accordance with an added feature of the invention, the score is relative to the sales effectiveness of other businesses.

In accordance with an additional feature of the invention, the score is normalized by the growth rate of the relevant market sector so the true sales performance of the business can be assessed. This means that businesses can be delineated in terms of those that have a growth rate above that of their respective market.

In accordance with yet another feature of the invention, businesses that lead the way in terms of sales effectiveness can be identified and subsequently used as role models.

In an exemplary embodiment, the first predetermined high range and second predetermined high range are each a lower percentage threshold of the total number of businesses in the plurality of businesses.

In accordance with yet a further feature of the invention, only the aggregate scores of high performing businesses are used to create the sales force effectiveness benchmark.

In an exemplary embodiment, the first predetermined high range and second predetermined high range are those businesses within the top quartile.

In accordance with yet an added feature of the invention, the benchmark can be set at a fair level without being too high.

In an exemplary embodiment, the first predetermined high range and second predetermined high range are the same ranges.

In accordance with yet an additional feature of the invention, the analysis is simplified and an equal weighting is applied to sales force effectiveness (a measure largely developed by qualitative investigations including staff surveys) and net growth rate (a more absolute quantitative measure calculated from the financials of the businesses and respective markets).

In an exemplary embodiment, the data communications device is a computer keyboard and mouse.

In an exemplary embodiment, the data communication device is a network card connecting the computer to the internet in use.

In accordance with again another feature of the invention, the sales effectiveness input data, revenue growth rate data and market sector growth rate data can be received from other sources manually or automatically over the Internet.

With the objects of the invention in view, there is also provided computer executable steps are provided for evaluating the sales force effectiveness of a selected business comprising:
receiving sales effectiveness input data relating to the sales effectiveness of a plurality of businesses;
receiving revenue growth rate data relating to the revenue growth rate of the plurality of businesses;
receiving market sector growth rate data relating to the growth rate of the market sectors of which the plurality of business are respectively a part;
calculating net real growth rate data for the plurality of businesses by normalizing the revenue growth rate data with respect to the respective market sector growth rate data;
creating a first business data set comprising data in relation to businesses that fall within a first predetermined high range in terms of their net real growth rate data;
creating a second business data set comprising data in relation to businesses that fall within a second predetermined high range in terms of their sales effectiveness data;
creating a high performing business data set comprising data in relation to businesses that are common to both the first business data set and the second business data set;
allocating a sales force effectiveness benchmark score that represents the average sales force effectiveness of the businesses in the high performing business data set; and
calculating a final score representing the sales force effectiveness of the selected business by calculating the difference between the sales force effectiveness of the selected business and the sales force effectiveness benchmark score.

In accordance with again a further feature of the invention, a quantitative score can be determined corresponding to the sales force effectiveness of a business and this score can be evaluated against a benchmark representing a proficient level of sales force effectiveness.

In accordance with again an added feature of the invention, the score is relative to the sales effectiveness of other businesses.

In accordance with again an additional feature of the invention, the score is normalized by the growth rate of the relevant market sector so the true sales performance of the business can be assessed. This means that businesses can be delineated in terms of those that have a growth above that of their respective market.

In accordance with still another feature of the invention, businesses that lead the way in terms of sales effectiveness can be identified and subsequently used as role models.

In an exemplary embodiment, the first predetermined high range and second predetermined high range are each a lower percentage threshold of the total number of businesses in the plurality of businesses.

In accordance with still a further feature of the invention, only the aggregate scores of high performing businesses are used to create the sales force effectiveness benchmark.

In an exemplary embodiment, the first predetermined high range and second predetermined high range are those businesses within the top quartile.

In accordance with still an added feature of the invention, the benchmark can be set at a fair level without being too high.

In an exemplary embodiment, the first predetermined high range and second predetermined high range are the same ranges.

In accordance with still an additional feature of the invention, the analysis is simplified and an equal weighting is applied to sales force effectiveness (a measure largely developed by qualitative investigations including staff surveys) and net growth rate (a more absolute quantitative measure calculated from the financials of the businesses and respective markets).

With the objects of the invention in view, there is also provided a computer program is provided comprising compiled code device adapted to carry out the computer executable steps of any one of the above paragraphs.

With the objects of the invention in view, there is also provided a method for evaluating the sales force effectiveness of a selected business is provided, comprising the following steps:
collecting sales effectiveness data from a plurality of businesses comprising sales teams comprising, in turn, sales related staff via a survey of the sales related staff, the sales effectiveness data being indicative of the sales effectiveness of the sales teams;
calculating the net real growth rate of the businesses as a function of the revenue growth rate of the businesses and the growth rate of a market sector of which the businesses are a part;
creating a first business group comprising businesses that fall within a first predetermined high range in terms of net real growth;
creating a second business group comprising businesses and that have sales teams that fall within a second predetermined high range in terms of sales effectiveness;
comparing the first business grouping to the second business grouping to create a high performing business group comprising only businesses that are common to both the first business group and the second business group;
creating a sales force effectiveness benchmark that represents the average sales force effectiveness of the businesses in the high performing business group; and
comparing the sales force effectiveness of the selected business with the sales force effectiveness benchmark to determine the sales force effectiveness of the selected business.

In accordance with another feature of the invention, the sales force effectiveness of a business can be evaluated against a benchmark representing a proficient level of sales force effectiveness.

In accordance with a further feature of the invention, the businesses can be delineated in terms of those that have a growth rate above that of their respective market.

In accordance with an added feature of the invention, the businesses that lead the way in terms of sales effectiveness can be identified and subsequently used as role models.

With the objects of the invention in view, there is also provided a method for improving the sales force effectiveness of sales related staff of a business to be improved, comprising the following steps:
1. carrying out the method for evaluating the sales force effectiveness of a selected business as described above for a plurality of businesses to provide the high performing business group;
2. examining knowledge, skills, processes employed, and/or behaviors exhibited by sales related staff of the businesses of the high performing business group; and
3. educating the sales related staff of the business to be improved with the knowledge, skills, processes employed and/or behaviors.

In accordance with a concomitant feature of the invention, the sales force effectiveness of a business can be improved by learning from the success of other businesses.

Other aspects of the invention are also disclosed.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

Other terms used herein are set forth below along with the respective descriptions.

Computer Implementation

It should be understood that in one embodiment one or more steps carried out by the computer code may be carried out on one computer and other steps be carried out on another computer.

Business:

It should be noted that the word “business” refers to any type of organization including not-for-profit organizations.

Wireless:

The invention may be embodied using devices conforming to other network standards and for other applications, including, for example other WLAN standards and other wireless standards. Applications that can be accommodated include IEEE 802.11 wireless LANs and links, and wireless Ethernet. In the context of this application, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. In the context of this document, the term “wired” and its derivatives may be used to describe circuits, devices, systems, methods, techniques, communications channels, etc., that may communicate data through the use of modulated electromagnetic radiation through a solid medium. The term does not imply that the associated devices are coupled by electrically conductive wires.

Processes:

Unless specifically stated otherwise, as apparent from the following discussions, it is appreciated that throughout the specification discussions utilizing terms such as “processing”, “computing”, “calculating”, “determining”, “analyzing” or the like, refer to the action and/or processes of a computer or computing system, or similar electronic computing device, that manipulate and/or transform data represented as physical, such as electronic, quantities into other data similarly represented as physical quantities.

Processor:

In a similar manner, the term “processor” may refer to any device or portion of a device that processes electronic data, e.g., from registers and/or memory to transform that electronic data into other electronic data that, e.g., may be stored in registers and/or memory. A “computer” or a “computing device” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. The processing system further may include a memory subsystem including main RAM and/or a static RAM, and/or ROM.

Networked or Multiple Processors:

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a web appliance, a network router, switch or bridge, or any machine capable of executing a set of instructions (sequential or otherwise) that specify actions to be taken by that machine.

It is noted that, while some diagram(s) only show(s) a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

### Additional Embodiments

Thus, one embodiment of each of the methods described herein is in the form of a computer-readable carrier medium carrying a set of instructions, e.g., a computer program that are for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

Computer Readable Memory:

While the computer readable memory is shown in an example embodiment to be a single computer readable memory, the term “computer readable memory” should be taken to include a single memory or multiple memory (e.g., a centralized or distributed database, and/or associated caches and servers) that store the one or more sets of instructions. The term “computer readable memory” shall also be taken to include any memory that is capable of storing, encoding, or carrying a set of instructions for execution by one or more of the processors and that cause the one or more processors to perform any one or more of the methodologies of the present invention. A computer readable memory may take many forms, including but not limited to, non-volatile media, volatile media, and transmission media.

Implementation:

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Measures For Carrying out a Method or Function

Furthermore, some of the embodiments are described herein as a method or combination of elements of a method that can be implemented by a processor of a processor device, computer system, or by other means of carrying out the function. Thus, a processor with the necessary instructions for carrying out such a method or element of a method forms a device or means for carrying out the method or element of a method. Furthermore, an element described herein of an apparatus embodiment is an example of a means for carrying out the function performed by the element for the purpose of carrying out the invention.

Operatively Connected

Similarly, it is to be noticed that the term “operatively connected”, when used in the claims, should not be interpreted as being limitative to direct connections only.

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment,” “in an exemplary embodiment,” or “in an embodiment” in various places throughout this specification are not necessarily all referring to the same embodiment, but may refer to different or alternative embodiments. Furthermore, the particular features, structures or characteristics may be combined in any suitable manner, as would be apparent to one of ordinary skill in the art from this disclosure, in one or more embodiments.

Similarly it should be appreciated that, in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of the Invention are hereby expressly incorporated into this Detailed Description of the Invention, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing an embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Comprising and Including

In the claims which follow and in the preceding description of the invention, except where the context requires otherwise due to express language or necessary implication, the word “comprise” or variations such as “comprises” or “comprising” are used in an inclusive sense, i.e., to specify the presence of the stated features but not to preclude the presence or addition of further features in various embodiments of the invention.

Any one of the terms including or which includes or that includes as used herein is also an open term that also means including at least the elements/features that follow the term, but not excluding others. Thus, including is synonymous with and means comprising.

### SCOPE OF INVENTION

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

Although the invention is illustrated and described herein as embodied in a computer and computer program for evaluating the sales force effectiveness of a selected business, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a block diagram of a computer for evaluating the sales force effectiveness of a selected business in accordance with an exemplary embodiment of the present invention; and

FIG. 2 is a graph of sales effectiveness vs. net real growth rate generated by the computer of FIG. 1.

### DETAILED DESCRIPTION OF THE INVENTION

The present invention relates to computers and computer programs used in evaluating the sales force effectiveness of businesses and in particular to those used by sales/marketing/management consultancies.

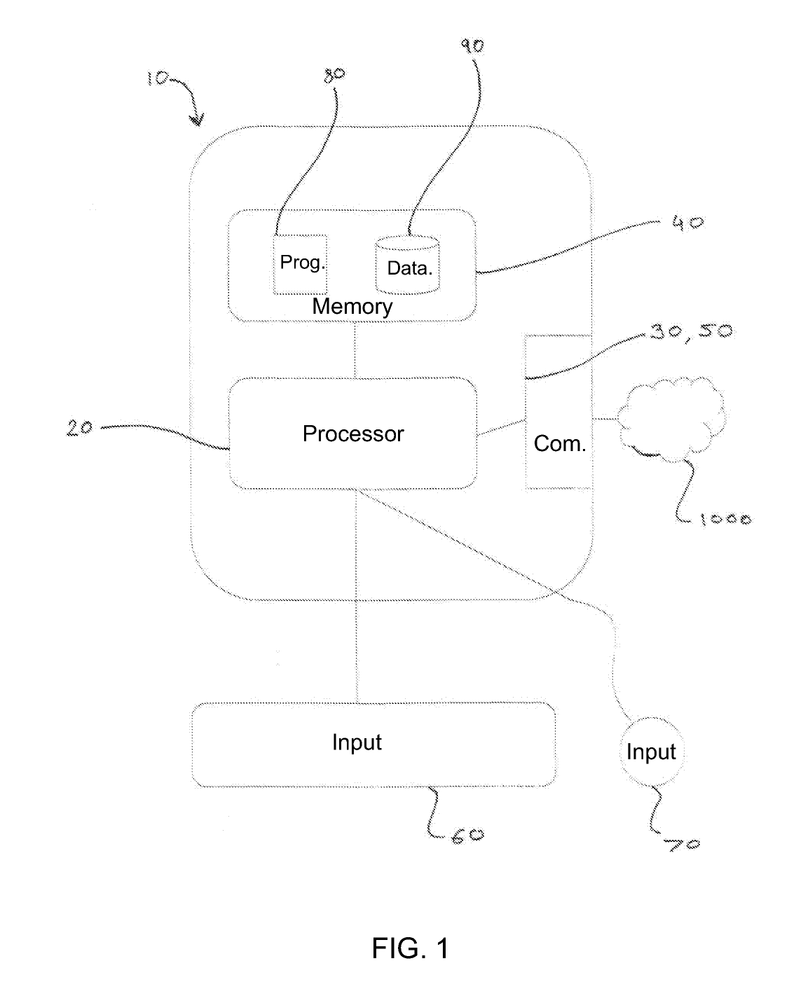

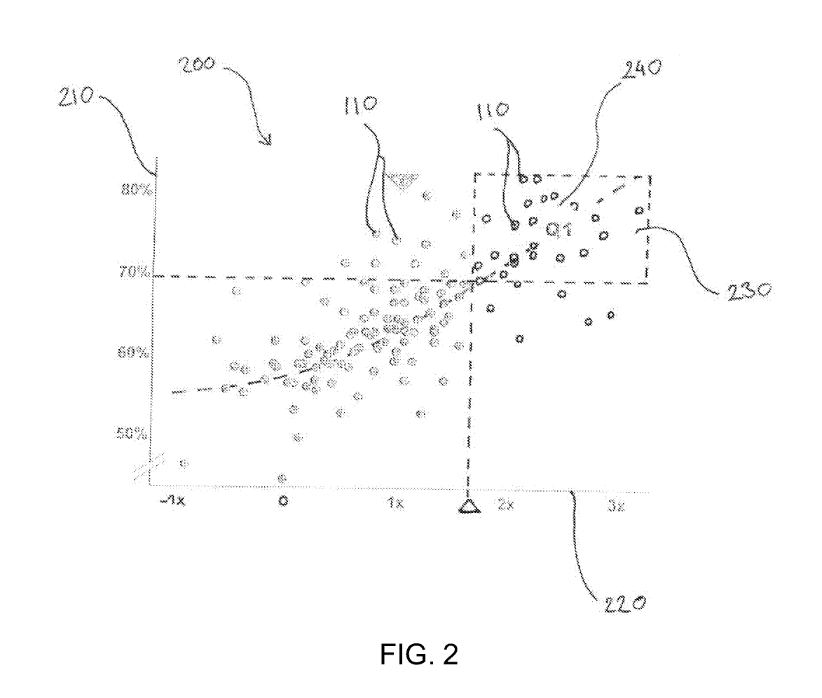

Described now are exemplary embodiments of the present invention. Referring now to the figures of the drawings in detail and first, particularly to FIGS. 1 and 2, there is shown a first exemplary embodiment of a computer 10 for evaluating the sales force effectiveness of a selected business comprising a processor 20, a data communication device 30 operatively connected to the processor 20, and computer readable memory 40 operatively connected to the processor 20.

In one exemplary embodiment, the data communications device 30 is a computer keyboard 60 and a mouse 70 or any other suitable input device. In another exemplary embodiment, the data communication device is a network card 50 connecting the computer to the Internet in use. The network card 50 may be wireless or adapted to receive a cable from a router as examples only. In the exemplary case of FIG. 1, the data communication device 30 takes the form of a network card 50 allowing the computer to connect to the internet 1000, a keyboard 60, and a mouse 70.

The computer readable memory 40 stores a program 80 and a database 90. The program 80 comprises compiled computer code adapted to carry out the following steps (computer executable steps) when run by the processor 20:
receiving sales effectiveness input data relating to the sales effectiveness of a plurality of businesses 110 via the network card 50 into the database 90;
receiving revenue growth rate data relating to the revenue growth rate of the plurality of businesses 110 via the network card 50 into the database 90;
receiving market sector growth rate data relating to the growth rate of the market sectors of which the plurality of businesses 110 are respectively a part via the network card 50 into the database 90;
calculating net real growth rate data for the plurality of businesses 110 by normalizing the revenue growth rate data with respect to the respective market sector growth rate data (e.g., by dividing the revenue growth rate data by the market sector growth rate data and adjusting to take account of any acquisitions etc.);
creating a first business data set comprising data in relation to businesses 110 that fall within a first predetermined high range in terms of their net real growth rate data;
saving the first business data set in the database 90;
creating a second business data set comprising data in relation to businesses 110 that fall within a second predetermined high range in terms of their sales effectiveness data;
saving the second business data set in the database 90;
creating a high performing business data set comprising data in relation to businesses 110 that are common to both the first business data set and the second business data set;
saving the high performing business data set in the database 90;
allocating a sales force effectiveness benchmark score that represents the average sales force effectiveness of the businesses 110 in the high performing business data set; and
calculating a final score representing the sales force effectiveness of the selected business by calculating the difference between the sales force effectiveness of the selected business and the sales force effectiveness benchmark score.

Referring to FIG. 2, a graph 200 is shown having a vertical sales effectiveness axis 210 and a horizontal net real growth rate axis 220. The graph 200 is generated by the computer 10 of FIG. 1 when the program 80 is run by the processor 20 and can be displayed, for example, on a non-illustrated monitor of the computer 10. The computer 10 can, then, generate and display a rectangle 230 surrounding the high performing business data set by creating a rectangle having a length corresponding to the first predetermined high range and a height corresponding to the second predetermined high range.

The present invention offers a number of advantages, including the following.
1. A quantitative score can be determined corresponding to the sales force effectiveness of a business and this score can be evaluated against a benchmark.
2. The score is relative to the sales effectiveness of other businesses.
3. The score is normalized by the growth rate of the relevant market sector so the true sales performance of the business can be assessed. This means that businesses can be delineated in terms of those that grow above the growth of their respective market.
4. Businesses that lead the way in terms of sales effectiveness can be identified and subsequently used as role models.

In one exemplary embodiment, the first predetermined high range and second predetermined high range are each a lower percentage threshold of the total number of businesses in the plurality of businesses 110, for example, a percentage falling in the range of 15%-35%. In one particular embodiment, the lower percentage threshold is 25%. Advantageously, only the aggregate scores of high performing businesses are used to create the sales force effectiveness benchmark.

In an exemplary embodiment, the first predetermined high range and second predetermined high range are those businesses 110 within the top quartile 240. Advantageously, the benchmark can be set at a fair level without being too high.

In an exemplary embodiment, the first predetermined high range and second predetermined high range are the same ranges. Advantageously, the analysis is simplified by applying an equal weighting to sales force effectiveness 210 and net growth rate 220. Sales force effectiveness 210 can be measured by any suitable method including by qualitative investigations including surveys of sales people/teams in relation to:
1. the extent to which the sales team believe in what they are selling;
2. the extent to which the sales team understand the sales strategy and execution process;
3. team motivation;
4. the motivation of the members of the sales team;
5. the attractiveness of the products/services being sold;
6. the extent to which sales coaching or other forms of on-the-job learning (e.g., buddy programs, training sessions, role modeling and networking) are utilized by the business;
7. the teams' level of product knowledge; and
8. the availability of/access to sales tools.

On the other hand, net growth rate 220 is a more absolute quantitative measure calculated from the financials of the businesses and respective markets. Thus, the computer 10 is able to evaluate sales force effectiveness using a holistic approach considering both subjective and objective information.

It should be appreciated that, if the plurality of businesses 110 are all from a predefined industry sector(s) (e.g., telecoms) or from a predefined geographic region(s) (e.g., Los Angeles), then the benchmark score will represent the benchmark for these industry sector(s) or geographic region(s), respectively.

Furthermore, if the sales effectiveness input data is limited to a particular customer segment(s) (e.g., business-to-business or business-to-customer), then the benchmark score will represent the benchmark for these customer segment(s).

The benchmark score can be defined in more than one respect, for example, it might be a benchmark score for telecoms businesses that operate in the Los Angeles region but that only service other businesses.

The scope of businesses to which the benchmark score relates can, therefore, be defined, effectively, by the plurality of businesses 110 that are selected and the selection of sales effectiveness data that is used in the process steps.

Advantageously, the sales effectiveness input data, revenue growth rate data and market sector growth rate data can be received from other sources manually or automatically over the internet.

In another exemplary embodiment, a method is provided for evaluating the sales force effectiveness of a selected business, comprising the following steps:
collecting sales effectiveness data from a plurality of businesses comprising sales teams comprising, in turn, sales related staff via a survey of the sales related staff, the sales effectiveness data being indicative of the sales effectiveness of the sales teams;
calculating the net real growth rate of the businesses as a function of the revenue growth rate of the businesses and the growth rate of a market sector of which the businesses are a part;
creating a first business group comprising businesses that fall within a first predetermined high range in terms of net real growth;
creating a second business group comprising businesses and that have sales teams that fall within a second predetermined high range in terms of sales effectiveness;
comparing the first business grouping to the second business grouping to create a high performing business group comprising only businesses that are common to both the first business group and the second business group;
creating a sales force effectiveness benchmark that represents the average sales force effectiveness of the businesses in the high performing business group; and
comparing the sales force effectiveness of the selected business with the sales force effectiveness benchmark to determine the sales force effectiveness of the selected business.
   This method offers a number of advantages:
1. The sales force effectiveness of a business can be evaluated against a benchmark and is relative to the sales effectiveness of other businesses.
2. Businesses can be delineated in terms of those that grow above the growth of their respective market.
3. Businesses that lead the way in terms of sales effectiveness can be identified and subsequently used as role models.

In another exemplary embodiment, a method is provided for improving the sales force effectiveness of sales related staff of a business to be improved, comprising the following steps:
1. carrying out the method for evaluating the sales force effectiveness of a selected business as described above for a plurality of businesses to provide the high performing business group;
2. examining knowledge, skills, processes employed and/or behaviors exhibited by sales related staff of the businesses of the high performing business group; and
3. educating the sales related staff of the business to be improved with the knowledge, skills, processes employed and/or behaviors.
   Advantageously, the sales force effectiveness of a business can be improved by learning from the success of other businesses.

It is apparent from the above, that the embodiments described are applicable to the sales/marketing/management consultancy industries.

In the claims which follow and in the preceding description of the invention, except where the context requires otherwise due to express language or necessary implication, the word “comprise” or variations such as “comprises” or “comprising” are used in an inclusive sense, i.e., to specify the presence of the stated features but not to preclude the presence or addition of further features in various embodiments of the invention.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

I claim:

1. A computer for evaluating the sales force effectiveness of a selected business, comprising:
a processor;
a data communication device operatively connected to the processor; and
computer readable memory operatively connected to the processor and storing a program, the program comprising code adapted to carry out the following steps when run by the processor:
receiving sales effectiveness input data relating to the sales effectiveness of a plurality of businesses through the data communication device into the computer readable memory;
receiving revenue growth rate data relating to the revenue growth rate of the plurality of businesses through the data communication device into the computer readable memory;
receiving market sector growth rate data relating to the growth rate of the market sectors of which the plurality of businesses are respectively a part through the data communication device into the computer readable memory;
calculating net real growth rate data for the plurality of businesses by normalizing the revenue growth rate data with respect to the respective market sector growth rate data;
creating a first business data set comprising data in relation to businesses that fall within a first predetermined high range in terms of their net real growth rate data;
creating a second business data set comprising data in relation to businesses that fall within a second predetermined high range in terms of their sales effectiveness data;
creating a high performing business data set comprising data in relation to businesses that are common to both the first business data set and the second business data set;
allocating a sales force effectiveness benchmark score that represents the average sales force effectiveness of the businesses in the high performing business data set; and
calculating a final score representing the sales force effectiveness of the selected business by calculating the difference between the sales force effectiveness of the selected business and the sales force effectiveness benchmark score.

2. The computer according to claim 1, wherein the first predetermined high range and second predetermined high range are each a lower percentage threshold of the total number of businesses in the plurality of businesses.

3. The computer according to claim 1, wherein the first predetermined high range and second predetermined high range are those businesses within a top quartile.

4. The computer according to claim 1, wherein the first predetermined high range and second predetermined high range are the same ranges.

5. The computer according to claim 1, wherein the data communications device is a computer keyboard and mouse.

6. The computer according to claim 1, wherein the data communication device is a network card connecting the computer to the Internet in use.

7. Computer executable steps for evaluating the sales force effectiveness of a selected business, comprising:
receiving sales effectiveness input data relating to the sales effectiveness of a plurality of businesses;
receiving revenue growth rate data relating to the revenue growth rate of the plurality of businesses;
receiving market sector growth rate data relating to the growth rate of the market sectors of which the plurality of businesses are respectively a part;
calculating net real growth rate data for the plurality of businesses by normalizing the revenue growth rate data with respect to the respective market sector growth rate data;
creating a first business data set comprising data in relation to businesses that fall within a first predetermined high range in terms of their net real growth rate data;
creating a second business data set comprising data in relation to businesses that fall within a second predetermined high range in terms of their sales effectiveness data;
creating a high performing business data set comprising data in relation to businesses that are common to both the first business data set and the second business data set;
allocating a sales force effectiveness benchmark score that represents the average sales force effectiveness of the businesses in the high performing business data set; and
calculating a final score representing the sales force effectiveness of the selected business by calculating the difference between the sales force effectiveness of the selected business and the sales force effectiveness benchmark score.

8. The computer executable steps according to claim 7, wherein the first predetermined high range and second predetermined high range are each a lower percentage threshold of the total number of businesses in the plurality of businesses.

9. The computer executable steps according to claim 7, wherein the first predetermined high range and second predetermined high range are those businesses within a top quartile.

10. The computer executable steps according to claim 7, wherein the first predetermined high range and second predetermined high range are the same ranges.

11. A computer program comprising compiled code means adapted to carry out the computer executable steps of claim 7.

12. A computer program comprising compiled code means adapted to carry out the computer executable steps of claim 8.

13. A computer program comprising compiled code means adapted to carry out the computer executable steps of claim 9.

14. A computer program comprising compiled code means adapted to carry out the computer executable steps of claim 10.

15. A computer program product, comprising a computer usable medium having a computer readable program code embodied therein, the computer readable program code adapted to be executed to implement a method for evaluating the sales force effectiveness of a selected business, the method comprising:
receiving sales effectiveness input data relating to the sales effectiveness of a plurality of businesses;
receiving revenue growth rate data relating to the revenue growth rate of the plurality of businesses;
receiving market sector growth rate data relating to the growth rate of the market sectors of which the plurality of businesses are respectively a part;
calculating net real growth rate data for the plurality of businesses by normalizing the revenue growth rate data with respect to the respective market sector growth rate data;
creating a first business data set comprising data in relation to businesses that fall within a first predetermined high range in terms of their net real growth rate data;
creating a second business data set comprising data in relation to businesses that fall within a second predetermined high range in terms of their sales effectiveness data;
creating a high performing business data set comprising data in relation to businesses that are common to both the first business data set and the second business data set;
allocating a sales force effectiveness benchmark score that represents the average sales force effectiveness of the businesses in the high performing business data set; and
calculating a final score representing the sales force effectiveness of the selected business by calculating the difference between the sales force effectiveness of the selected business and the sales force effectiveness benchmark score.

16. The computer program product according to claim 15, wherein the first predetermined high range and second predetermined high range are each a lower percentage threshold of the total number of businesses in the plurality of businesses.

17. The computer program product according to claim 15, wherein the first predetermined high range and second predetermined high range are those businesses within a top quartile.

18. The computer program product according to claim 15, wherein the first predetermined high range and second predetermined high range are the same ranges.
